(19) United States
(12) Patent Application Publication
(10) Pub. No.: US 2004/0148988 A1
(43) Pub. Date: Aug. 5, 2004

(54) Lock key with head and blade

(76) Inventor: Mark Raymond Taylor, St. George, UT (US)

Correspondence Address: Mark R. Taylor, P.O. Box 933, St. George, UT, 84771, US

(21) Appl. No.: 10/753,224

(22) Filed: Jan. 6, 2004

Related U.S. Application Data
(60) Provisional application No. 60/445,063, filed on Feb. 5, 2003.

(51) Int. Cl. E05B 19/04

(52) U.S. Cl. 70/408

(57) ABSTRACT

An improved lock key having exchangeable key heads manufactured from jewelry and an interlocking blade so that they cannot be separated from one another in normal usage. Thus providing a means for identification for which key operates which lock and to provide for a pleasing design with insignia.

### CROSS-REFERENCE TO RELATED APPLICATIONS

This Application claims the benefit of PPA Ser. No. 60/445,063, Filed Feb. 5, 2003 by the present inventor.

### FEDERALLY SPONSORED RESEARCH

Not Applicable

### SEQUENCE LISTING OR PROGRAM

Not Applicable

### BACKGROUND

1. Field of Invention

This invention relates to a multipart key combining an improved head portion manufactured from jewelry.

2. Description of Prior Art

Since the introduction of keys and locks, key identification to which lock it is intended to fit has been a problem. The increased need for security has made the key the single most commonly carried personal article. Yet, one key looks and feels like another and if the owner is unable to identify his key it is unlikely that any one else can do so. This problem has been partially solved by the implementation of the key head replacements, but this had significant problems. Plastic, resin, rubber, and metal key heads have had limited success or have been completely unsuccessful.

Plastic and resin key heads have proved inferior due to the fact that they are unattractive and scratch easy. Also, these key heads lack a means for receiving a graphic inscription thereon. Thus, the user must remember the color code or have a separate memorandum of the color code. The processes of assembly required the locksmith to have an assembly tool that was economically too expensive to acquire and was too large for a small shop or van. Also, the locksmith must have available a very large number of key blanks of different types and colors from which to allow customers to choose from.

Rubber key covers have proved inferior due to the fact that they are unattractive, and become soiled with dirt, oil, and stains.

Metal key heads may be etched with an engraver; however, the engraving is often difficult to read, particularly in poorly lighted areas, and the identification information is not easily changed.

Current keys are also one of the most common objects but are one of the most inordinate, inartistically designed, and mundane.

Finally, the above methods are commercially unacceptable to the public, they are a market failure, they are too expense to manufacture, and still haven't solved the problem of which key opens which lock.

### BACKGROUND—OBJECTS AND ADVANTAGES

To provide a composition of two currently successful products. This invention provides the composition of a key blade and jewelry.

To provide a new use of an existing product. This invention provides a new use of jewelry.

To provide in general an improved key.

To provide added value to a key with the addition of advertising for other products.

To provide brand recognition between keys and key manufactures.

To provide a tactile feel to keys to aid in selection of proper key in low light and dark conditions.

To provide a key with added value.

To provide a key with the feature in which the shape, coloring, design, indicia and decoration of the head could be selected to suit the tastes of the buyer or to carry desired information, identification, etc. Such identification could include the name of club, team, affiliation, or organization.

To provide a key which is aesthetically pleasing and durable.

To provide a key, which can generally inexpensive, can be manufactured on present equipment, and can be handled by the existing lock shops.

To provide a key head that can be attached securely to a key that contains identifying information for which lock the key will operate. Also, to provide a key that simplifies the determination of key for a lock.

To provide an identifying key head for identification of the key, and which can be changed if the identification of the key is to be changed.

To provide an identifying key head which makes reading of the identifying information on the key head easier in dark or poorly lighted areas.

To provide a key head for identifying keys which contains insignia for quick differentiation of keys to various types of classes of locks.

To provide a key, which has improved, pleasant tactile and visual factors and which most people prefer over the standard key.

Further objects and advantages of this invention will become apparent from a consideration of the drawings and ensuing description.

### SUMMARY

The lock key embodied in the present invention comprises an elongated key blade which, following conventional practice, is formed of metal. The key head, however, is formed of jewelry such as a cloisonn\acute{e} pin or a lapel pin, said key head sufficiently attached to the key blade. The key head and the key blade are interlocked so that key cannot be separated from one another in normal usage.

This invention therefore provides a key head, which contains identifying information for the key to indicate which lock the key will operate or a key with the feature in which the shape, coloring, design, indicia and decoration of the head could be selected to suit the tastes of the buyer.

In addition, the key assembly, although perfectly rigid, can also be readily taken apart so that it is possible for example to change the key blade of the key without changing the key head which can be of advantage in cases where locks are changed, when moving residence, or when changing vehicles. Finally, the blank manufacture can offer a large selection of key types and styles without having to have a large stock of key blanks.

### DRAWING—FIGURES

Referring to the accompanying drawings for a clearer understanding of this invention:

FIG. 1 is a perspective view of this invention

FIG. 2 is a perspective view of this invention

FIG. 3 is a perspective-exploded view of this invention

FIG. 4 is a perspective-exploded view of this invention

FIG. 5 is a top view of this invention

FIG. 6 is an exploded view of this invention

FIG. 7 is a sectional view taken along line 1-1 of FIG. 7

### DRAWINGS—REFERENCE NUMERALS

Referring to the accompanying drawings the numerals describe the parts of this invention:

10 Key
11 Head
12 Blade
13 Key Ring Hole
14 Serrations
15 Receiving Slot
16 Inserting Portion
17 Insignia
18 Storage Hole

### DESCRIPTION—OPERATION

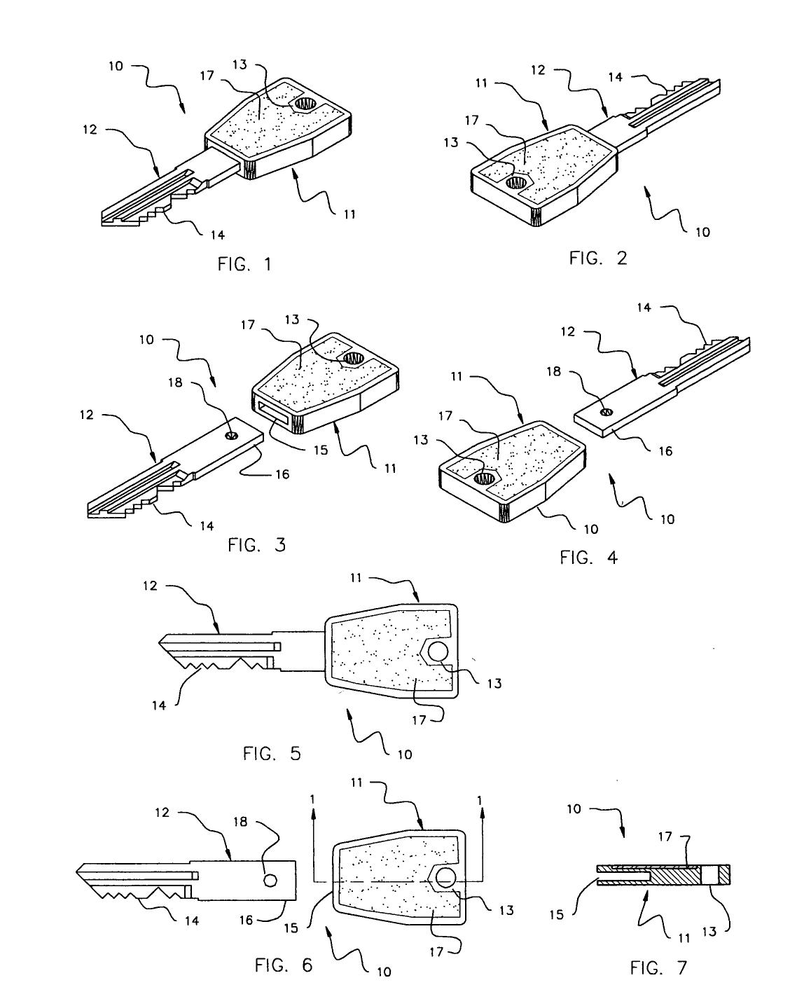

As shown in FIGS. 1 and 2, the key 10 relating to the first embodiment of this invention comprises a blade 12, also called a key body, made of metallic material (such as brass, iron or steel) and using jewelry material as a head 11, also called a bow, which is connected to said blade 12.

The above-mentioned key 10 consists of a blade 12 on which serrations 14 are to be formed for use in opening a lock. Also, the blade 12 forms an inserting portion 16, which is integrated into the above-mentioned key head 11. In the key head 11 there is provided a receiving slot 15 or opening for receiving the inserting portion 16 of the blade 12. The key head 11 is connected to the blade 12 in such manner that said inserting portion 16 is reasonably held. Methods of holding key head 11 to blade 12 include but are not limited to friction, glue, epoxy, or welding.

The above-mentioned key head 11 is made of jewelry such as, but not limited to, a cloisonne pin also know as a lapel pin, an enameled pin, an EPOLA pin, or a photo-etched pin. Said key head 11 being manufactured from materials such as plastic, glass, paint, resin, rubber, gemstones, brass, bronze, copper, steel, silver, and gold. Common processes of manufacture of key head 11 are referred to as: cloisonné, soft enamel, hard enamel, EPOLA, or, photo etching.

Referring to FIGS. 5 and 6 it can be seen that in order to assemble the blade 12 into the key head 11, it is merely necessary to insert the inserting portion 16 of the blade 12 into the key head 11 through the receiving slot 15.

The key head 11 shape provides several insignia 17 surfaces as noted on the drawings to provide an area for decorative design, advertising, or insignia of which none has been specifically illustrated. Adhesive labels may also be used for key identification on insignia 17 surfaces. Thus when a locksmith, for example, wishes to provide a specific design of a key head 11, the key head 11 may be rapidly installed into the key blade 12 containing the proper serrations 14 for a particular lock.

Also, key blade 12 contains a storage hole 18 for use by locksmith to store unused blades 12.

Also, key head 11 contains a key ring hole 13 permitting a key ring, hook or other holder to pass through so that a number of keys may be grouped together for normal use.

### DESCRIPTION—ADDITIONAL EMBODIMENT

Not Applicable

### DESCRIPTION—OPERATION—ADDITIONAL EMBODIMENT

Not Applicable

### DESCRIPTION—CONCLUSIONS, RAMIFICATIONS, AND SCOPE

As can be seen from the drawings and descriptions of the preferred embodiment, many of the features of the invention may differ in detail while still being within the scope of the claimed invention. For example, the size, shape, color, and insignia may vary. The various elements of the key head of the present invention are dictated only by desired jewelry material, strength, aesthetic appeal, and customer preference.

For instance, the process for jewelry manufacture may include, but is not limited to, cloisonne pins. Cloisonne pins, also called enameled pins, are popular because of their hard durable finish. The colors are clearly separated by a fine gold or silver line to bring out bold colors and designs. These pins have a high-perceived value and their bright vivid colors can be color matched. Another popular manufacturing process is called EPOLA. It uses raised and recessed areas to depict the design. EPLOA is an excellent choice for price and quality. Also, another manufacturing process is the use of photo etching. It offers a similar look to the cloisonné. The photo-etched process allows for detailed designs and a wider spectrum of colors to choose from. All methods of manufacture allow many custom shapes and sizes. The method of jewelry manufacture should not be limited to cloisonné, EPOLA, photo-etched, enameled paint, soft enamel, or hard enamel techniques.

Also, jewelry material is not limited to rubber, plastic, resin, enamel, metal, gemstones, or glass. Similarly, the means of securing the key cover to the key may take any one of a number of forms, and those illustrated are intended as exemplary only and not as limiting this invention, departing from the spirit of this invention, nor the scope of this invention.

I claim:

1) A system for lock keys comprising:
a) a key head of jewelry material
b) an elongated key blade
c) means for joining said elongated key blade outwardly from said key head as to be able to operate a lock

2) A lock key according to claim 1 comprising:
a) said key head wherein the surfaces provide an area which graphic indicia markings are displayed.

3) A lock key according to claim 1 and 2 in which said suitable materials containing rubber, plastic, resin, metal, gemstones, or glass.
